(19) United States
(12) Patent Application Publication
(10) Pub. No.: US 2017/0044058 A1
(43) Pub. Date: Feb. 16, 2017

(54) METHOD FOR MANUFACTURING THIN GLASS

(71) Applicants: SAINT-GOBAIN ADFORS, Chambery (FR); SAINT-GOBAIN GLASS FRANCE, Courbevoie (FR)

(72) Inventors: Eric JANIAUD, Drancy (FR); Pierre-Olivier PETIT, Paris (FR); Benjamin BLANCHARD, Taverny (FR)

(73) Assignees: SAINT-GOBAIN ADFORS, Chambery (FR); SAINT-GOBAIN GLASS FRANCE, Courbevoie (FR)

(21) Appl. No.: 15/306,843

(22) PCT Filed: Apr. 22, 2015
(86) PCT No.: PCT/FR2015/051097

§ 371 Date: Oct. 26, 2016

(30) Foreign Application Priority Data
Apr. 28, 2014 (FR) 1453837

(51) Int. Cl. C03C 25/10; C03C 3/118; C03C 8/16; C03C 8/06; C03C 25/42; C03C 13/00

(52) U.S. Cl. CPC C03C 25/1095; C03C 25/42; C03C 13/00; C03C 8/16; C03C 8/06; C03C 3/118; C03C 2218/17; C03C 2207/00; C03C 2213/00

(57) ABSTRACT

The invention relates to a process for manufacturing flat glass, comprising the following successive steps:
(a) applying a layer of a glass frit to a glass textile, the glass of the frit and of the textile having essentially the same composition,
(b) heating the glass textile bearing the layer of glass frit to a temperature T>T_{L}−20° C., T_{L} being the Littleton temperature of the glass frit, for a sufficient length of time to convert the layer of frit into an enamel layer of the same composition as the glass textile, and
(c) cooling the glass textile impregnated with the enamel or bearing an enamel layer, obtained in step (b), so as to obtain a glass sheet.

It also relates to a glass sheet capable of being obtained by this process.

The present invention relates to a novel process for manufacturing flat glass, in particular thin glass sheets comprising a glass textile incorporated in a glass matrix.

Many glass manufacturers have for a few years produced what is referred to in English as ultra-thin glass (“verre pelliculaire” or “verre ultramince” in French) having a thickness comprised between a few tens of microns and about 300 μm. This glass, manufactured by float or fusion draw process, is available in large sheets or in the form of continuous strips. The thinnest ultra-thin glass is flexible and may be rolled up. This flexibility allows it to be used in industrial processes conventionally reserved for films and sheets made of plastic, in particular roll-to-roll processing.

The fusion draw process results in thin, transparent glass that is characterized by its exceptional surface smoothness, particularly important in high-technology applications such as LCD screens. However, the fusion draw process is complex, unproductive and difficult to control, and the high cost of the glass it produces is prohibitive for many applications.

The present invention provides a replacement product for known thin and ultra-thin glass, and a manufacturing process that is considerably simpler than the fusion draw process.

Most of the thin glasses of the present invention have an optical quality (transparency) lower than that of known thin glass. However, their surface quality is satisfactory. They are fabricated from cheap raw materials (glass textile and glass frit) available in large quantities and in various qualities.

The basic idea behind the present invention is to take advantage of the similarity between glass textiles and ultra-thin glass. Specifically, these two types of products have a similar chemical composition, geometry, and mechanical behavior, and mainly differ in their permeability to fluids and their transparency.

The process of the present invention decreases and even removes the permeability of glass textiles to fluids, and increases their transparency to light, thus making them more like thin and ultra-thin glass.

To achieve this objective, a glass textile has its apertures filled, its scattering interfaces reduced in number, and its surface smoothed by incorporating it into a glass matrix resulting from melting a glass frit applied to the textile at a temperature below the glass transition temperature of the glass.

The Applicant has filed two international patent applications PCT/FR2013/052571 and PCT/FR2013/052576, which were as yet published at the time of filing of the present patent application, disclosing a process for manufacturing flat glass by impregnating a glass textile with a molten glass composition, the glass of the impregnation composition having a glass transition temperature and a softening temperature below that of the glass of the textile. In this way, the impregnation composition may be heated to quite high temperatures, at which its viscosity is low, without however significantly decreasing the mechanical strength of the textile.

The flat glass products obtained by the process however suffer from a relatively low transparency, due to the difference in the refractive indices of the two types of glass, and also from a quite high mechanical fragility that the Applicant attributes to the difference between the thermal expansion coefficients of the two types of glass.

The present invention relates to a process similar to that described in patent application PCT/FR2013/052571, but that differs therefrom in that the glass making up the textile and the frit used for the impregnation have essentially the same composition, this posing specific manufacturing problems but yielding products with a better transparency and mechanical strength.

The process of the present invention is characterized by a very high flexibility. Specifically, the glass textile and the glass matrix may be chosen from a very large number of products available on the market.

The process of the present invention may be implemented with tools that require relatively few large investments, this representing a considerable advantage over float and fusion draw processes.

One subject of the present invention is a process for manufacturing flat glass, comprising the following successive steps:

(a) applying a layer of a glass frit to a glass textile, the glass of the frit and the glass of the textile having essentially the same composition,

(b) heating the glass textile bearing the layer of glass frit to a temperature T>T_{L}−20° C., T_{L} being the Littleton temperature of the glass frit, for a sufficient length of time to convert the layer of frit into an enamel layer of the same composition as the glass textile, and

(c) cooling the glass textile impregnated with the enamel or bearing an enamel layer, obtained in step (b), so as to obtain a glass sheet.

In the present application the expression “softening temperature” denotes what is called the Littleton temperature (T_{L}), also called the Littleton point, determined according to standard ASTM C338. This is the temperature at which the viscosity of a glass fiber measured according to this method is equal to 1×10⁶⁶ Pa·s.

The process is limited to the manufacture of a product from a glass textile and a glass-frit powder having essentially the same composition. The expression “the same composition” means that the two glasses contain the same ingredients—without however considering elements present in the form of impurities (<1% by weight). The difference between the respective concentrations of ingredients is at most 5% by weight and preferably at most 2% by weight, relative to the lowest concentration.

By way of example, when the glass forming the glass textile includes 30% by weight of a given ingredient, the concentration of the same ingredient in the glass forming the frit is comprised between 28.6 and 31.5% by weight and preferably between 29.4 and 30.6% by weight.

The difference in refractive index between the two glasses is preferably at most equal to 0.02 and in particular at most equal to 0.01.

The glass-frit composition may be applied in step (a) using well-known techniques such as screen printing, spiral rod coating, coating by means of a doctor blade or a bar coater, roll coating, bar coating or slot coating. Screen printing is a particularly preferred application technique because it may be easily implemented on an industrial scale and allows a good control of the quantities applied.

Although the products obtained by the process of the present invention are “flat” products in the sense that overall they preserve the geometry of the textile, which is characterized by two main surfaces that lie parallel to each other, the process of the present invention is in no way limited to perfectly flat products. Specifically, initial trials carried out by the Applicant resulted in materials that were very satisfying from an aesthetic point of view, and it would be entirely envisageable to use them to manufacture decorative objects of various shapes, such as lampshades, tubes, corrugated or bent walls, etc.

With regard to more technical applications, the products obtained by the process of the present invention however preferably have a both flat and planar shape. To obtain a final product with satisfactory planarity, it is possible to melt the frit on a textile positioned vertically, so that gravity acts parallel to the plane of the textile. When the textile is in a position that differs from the vertical position by too large a degree, in particular when it is in a horizontal position, it is essential to stretch the glass textile at least during the cooling step, and preferably throughout the process.

In one preferred embodiment, the glass textile is therefore subjected is to a tensile force in at least one direction in the plane of the glass textile, throughout step (b), and this tensile force is preferably maintained during step (c), at least until the product obtained has stiffened.

Placing the glass textile under tension during the step of melting/applying the glass and the cooling step is perfectly compatible with and even necessary for implementation of a continuous process, which is a preferred embodiment of the present invention.

In such a continual process, the glass textile is a continuous strip and steps (a), (b) and (c) are continuous steps implemented upstream and downstream in the processing line, the direction of the tensile force being parallel to the run direction of the continuous strip of glass textile.

The glass textile may be a nonwoven (mat), a knit or even a woven. When it is a woven, the number of warp threads and/or the number of weft threads is typically comprised between 3 and 100 per cm, and preferably between 10 and 80 per cm.

The objective of the present invention is to fill all the holes in the glass textile. To achieve this aim, it is indispensable to ensure that the apertures of the starting textile are not too large. Glass woven or nonwoven textiles with apertures having an average equivalent diameter smaller than 1 mm, and preferably smaller than 0.1 mm, will therefore preferably be chosen.

The weight per unit area of the glass textiles used is generally comprised between 30 and 500 g/m², preferably between 80 and 400 g/m², and in particular between 100 and 250 g/m².

The amount of glass applied in the form of glass-paste or glass-frit composition is comprised in the interval ranging from 100 to 2000 g/m², and preferably from 200 to 1500 g/m².

This amount of glass may of course be applied in one go, i.e. in a single layer or indeed in a plurality of layers.

The glass-frit (glass-paste) composition generally contains from 50 to 90% by weight and preferably from 65 to 85% by weight of a glass powder, and 10 to 50% by weight and preferably 15 to 35% of a binder, or medium, formed from an organic polymer dissolved in a solvent.

The heating step (step (b)) then preferably includes a plurality of temperature plateaus, the first plateau (100° C.-200° C.) serving to evaporate the solvent, the second plateau (350-450° C.) to eliminate the organic polymer, and the third plateau (about 600° C.) to melt the glass frit. The two first temperature plateaus are preferably each maintained for a length of time comprised between about 10 minutes and 1 hour and in particular between 15 and 30 minutes.

The third heating step intended to make the glass melt must be carried out for a time that depends on the temperature at which the melting occurs. The higher this temperature is, the shorter the time must be to prevent destruction of the film, which occurs at a rate proportional to the viscosity of the glass.

This heating may thus be carried out in a flash heating step comprising increasing the temperature of the textile by several hundred degrees, typically to T_{L}+100° C., in a few seconds. Such flash heating is particularly advantageous with a view to a continual industrial process and may, for example, be carried out by a laser sheet, a bank of plasma torches, a bank of burners, or by heating elements (Joule heating, induction heating, microwave heating).

After the frit and the textile have been completely melted, the film obtained is cooled (step (c)). This cooling may be passive or be controlled, for example by maintaining the impregnated textile in a hot environment. In order to ensure a good temperature uniformity throughout the cooling step, it may also be useful to heat certain zones liable to cool more rapidly than others.

The minimum temperature to which it is necessary to heat the frit in order to make it melt is equal to T_{L}−20° C. At this temperature, the time required to completely melt the frit is however quite long, about 2 h. It is generally desirable to heat the textile bearing the frit to higher temperatures, in particular m higher than or equal to the Littleton temperature, and preferably temperatures higher by at least 10° C., or even at least 20° C. than the Littleton temperature. When the textile with the frit is heated to a temperature higher by 10° than the Littleton temperature, the time required to melt the frit layer is generally about a few minutes.

For most glasses, when the heating temperature is too high a crystallization effect, also called devitrification, ensues, which significantly and sometimes undesirably decreases the transparency of the final product.

For the E glass tested by the Applicant, it was possible to limit or even prevent this crystallization by heating the textile with the frit to a temperature comprised between T_{L}−20° C. and T_{L}+20° C. For other types of glass, the extent of this optimal temperature range may however be different, larger or smaller. This optimal heating range will however generally be centered on the Littleton temperature.

The hot glass textile obtained in step (b) preferably does not make contact with any solids or liquids before it has cooled to a temperature at least 50° C. and preferably at least 100° C. below the softening temperature of the glass forming the molten glass composition.

The flat glasses obtained in the examples below were prepared using a relatively simple process at atmospheric pressure. When the final product contains many air bubbles not removed during melting, it could be advantageous to subject the textile with the enamel still hot to a low pressure.

To the knowledge of the Applicant, at the present time no description exists of a flat product obtained by combining a glass textile and a molten glass composition. Such a flat product, or glass sheet, capable of being manufactured by a process such as described above, is therefore another subject of the present invention.

This glass sheet preferably has a thickness comprised between 50 μm and 1000 μm, in particular between 100 μm and 800 μm, and ideally between 120 and 500 μm.

In this glass sheet, the structure of the glass textile may, due to its transparency, be visible to the naked eye. This structure may also be masked by a highly diffusive glass film, or it may even no longer be visible due to the disappearance of the interfaces between the textile material and the enamel coating the latter.

### EXAMPLE 1

A mat of E glass is coated with a glass paste consisting of a dispersion of E-glass powder of particle size smaller than 63 μm in an organic solvent, using a bar coater.

The composition of the glass of the textile and of the frit used for this example is the following:

| | oxide | | | | | | | | | | | |
|---|---|---|---|---|---|---|---|---|---|---|---|---|
| | SiO₂ | Al₂O₃ | CaO | MgO | SrO | B₂O₃ | Na₂O | K₂O | TiO₂ | F | Fe₂O₃ | SO₃ |
| wt % | 54.75 | 14.4 | 22.5 | 0.5 | 0.15 | 5.75 | 0.35 | 0.5 | 0.35 | 0.4 | 0.3 | 0.01 |

The glass textile is a glass mat formed from 166 warp threads (68 den) per 10 cm and 124 weft threads per 10 cm. Its weight per unit area is 205 g/m² and its thickness about 170 μm.

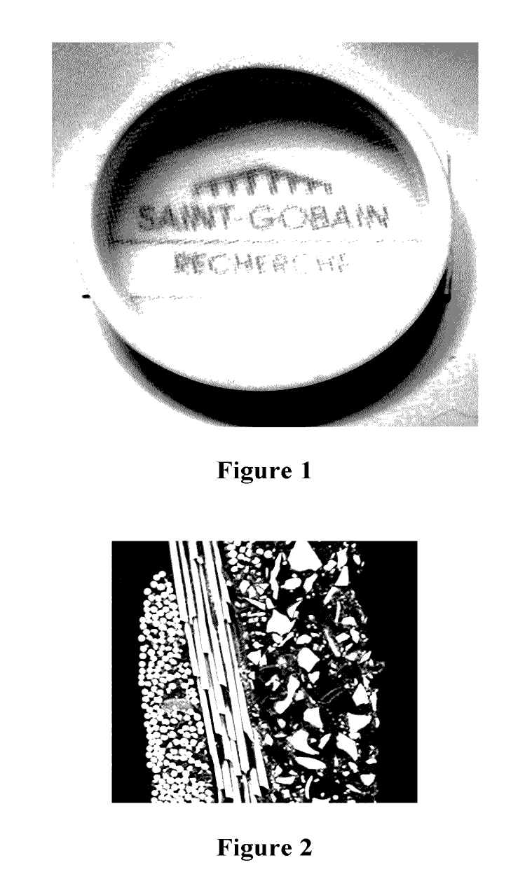

After coating, the coated textile is dried for 30 minutes at 120° C. The thickness of the dried film is 400 μm. The textile is then fixed to a refractory frame and annealed in an oven at 860° C. for 40 minutes. After cooling to room temperature, the film shown in FIG. 1 is obtained. Its final thickness is 200 μm. The surface preserves the imprint of the initial texture of the textile and weakly scatters light. The film forms a gas-tight barrier.

FIG. 2 is a cross-sectional view taken by electron microscopy of the textile after coating and before baking: the grains of the coating and the fibers of the textile are distinctly visible.

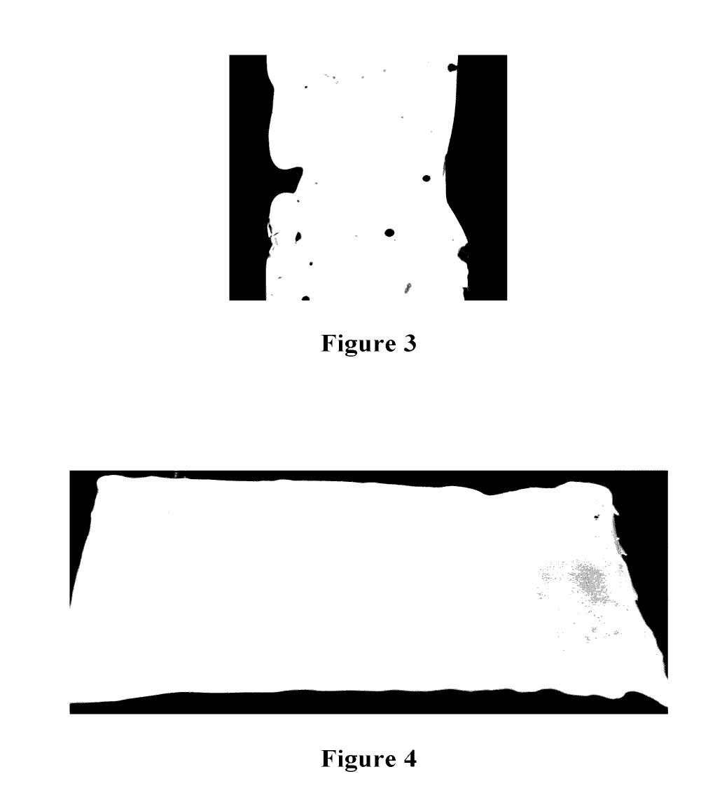

FIG. 3, also a cross-sectional view obtained by electron microscopy, shows the structure of the film obtained after baking. It is no longer possible to see the fibers and the grains. The result is a film that is impermeable to gas, containing a few rare closed pores.

### Example 2

Example 1 is repeated, with the same type of E-glass textile and the same E-glass frit, the only difference being that the sample is of larger size (about 150 cm² instead of 20 cm² for example 1). After coating, and drying of the coated textile for 30 minutes at 120° C., the bake is carried out for 20 minutes at 870° C. in an oven.

FIG. 4 shows the solidified film obtained.

1. A process for manufacturing flat glass, the process comprising:
(a) applying a layer of a glass frit comprising a glass powder to a glass textile, the glass of the glass powder and of the glass textile having essentially the same composition,
(b) heating the glass textile bearing the layer of glass frit to a temperature T>T_{L}−20° C.,
wherein T_{L} is the Littleton temperature of the glass powder, thereby converting the layer of frit into an enamel layer of the same composition as the glass textile and thereby obtaining a glass textile impregnated with the enamel or bearing an enamel layer, and
(c) cooling the resulting glass textile impregnated with the enamel or bearing an enamel layer, thereby obtaining a glass sheet.

2. The process of claim 1, wherein the applying (a) is carried out by screen printing, spiral rod coating, coating with a doctor blade or a bar coater, roll coating, or slot coating.

3. The process of claim 1, wherein the heating temperature T is at least equal to T_{L}.

4. The process of claim 1, wherein the heating (b) comprises, throughout the heating, subjecting the glass textile to a tensile force in at least one direction in the plane of the glass textile, and
wherein the process further comprises maintaining the tensile force during the cooling (c) at least until the glass sheet has stiffened.

5. The process of claim 1, wherein the glass textile has a weight per unit area of between 30 and 500 g/m².

6. The process of claim 1, wherein the amount of glass powder applied from 100 to 2000 g/m².

7. The process of claim 1, wherein the glass textile has apertures with an average equivalent diameter smaller than 1 mm.

8. The process of claim 1, wherein the glass textile is a woven having a number of warp threads and/or a number of weft threads of between 3 and 100/cm.

9. The process of claim 1, wherein the glass textile is a nonwoven.

10. The process of claim 1, wherein the hot glass textile impregnated with the enamel or bearing an enamel layer obtained in the heating (b) does not make contact with any solids or liquids before cooling to a temperature at least 50° C. lower than T_{L}.

11. A glass sheet obtained by the process of claim 1.

12. The glass sheet as claimed in claim 11, having a thickness of between 50 μm and 1000 μm.

13. The glass sheet of claim 11, wherein the structure of the glass textile is visible to the naked eye.

14. The process of claim 1, wherein the glass frit comprises from 50 to 90% by weight of a glass powder, and from 10 to 50% by weight of an organic polymer dissolved in a solvent.

15. The process of claim 14, wherein the heating (b) comprises:
heating the glass textile bearing the layer of glass frit at a first temperature of from 100° C. to 200° C., thereby evaporating the solvent,
heating the resulting glass textile bearing the layer of glass frit at a second temperature of from 350 to 450° C., thereby eliminating the organic polymer, and
heating the resulting glass textile bearing the layer of glass frit at a third temperature T higher than the second temperature and higher than T_{L}−20° C., thereby melting the glass powder.

16. The process of claim 1, wherein the heating (b) does not comprise devitrification.

17. The process of claim 1, wherein the heating temperature T is between T_{L}−20° C. and T_{L}+20° C.
